(19) United States
(12) Patent Application Publication
(10) Pub. No.: US 2005/0262453 A1
(43) Pub. Date: Nov. 24, 2005

(54) Modular data management system

(76) Inventor: Luca Massasso, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/873,871

(22) Filed: Jun. 21, 2004

Related U.S. Application Data
(60) Provisional application No. 60/573,091, filed on May 21, 2004.

(51) Int. Cl. G06F 17/60

(52) U.S. Cl. 715/965

(57) ABSTRACT

Embodiments include a system for providing a configurable user interface for displaying data in business and similar data type patterns. The system is designed to decouple the components relating to the user interface, business logic and persistent storage layers. Decoupling these components enhances the reusability of each component with other components or platforms and facilitates the update, customization and replacement of components in the system. The user interface may be configured to facilitate the display and manipulation of data for any type of data or pattern including time series data

The application is a Non-Provisional application claiming the priority of Provisional Application Ser. No. 60/573,091, filed May 21, 2004, by applicant Massasso Luca entitled “Axle Grid in a Web Environment.”

### BACKGROUND

1. Field of the Invention

The embodiments of the invention relate to user interfaces. Specifically, embodiments of the invention relate to configurable user interfaces for displaying data according to a defined pattern.

2. Background

Business and other enterprises that manage large amounts of data utilize software to facilitate the storage and manipulation of the data. This data is often related to specific aspects of a business process. Data related to different business processes have different properties and inter-relationships. These inter-relationships and data types must be accessible to users to view and modify the data.

Specialized software applications are created to manage data for each type of business process. A business or enterprise must utilize separate software applications to handle each different business process. For example, a business utilizes one software application to handle supply chain management and another to handle human resource data. Having separate software applications for each process results in increased costs for maintenance of the multiple systems utilized because each has separate computing requirements and requires the expertise of different individuals. A business must retain and train a large number of employees to maintain these software systems or must contract with multiple software providers to meet its needs.

The specialized software applications have monolithic designs. This makes modifying, customizing and updating the software applications difficult. As a result, the software application may have to be replaced at more frequent intervals incurring increased costs in purchasing the software and converting data to a new system.

### SUMMARY

Embodiments include a system for providing a configurable user interface for displaying data in business and similar data type patterns. The system is designed to decouple the components relating to the user interface, business logic and persistent storage layers. Decoupling these components enhances the reusability of each component with other components or platforms and facilitates the update, customization and replacement of components in the system. The user interface may be configured to facilitate the display and manipulation of data for any type of data or pattern including time series data.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of an application for managing data.

FIG. 2 is a diagram of one embodiment of a user interface of the application.

FIG. 3 is a flowchart of one embodiment of a process for generating a display of data according to a data pattern.

FIG. 4 is a flowchart of one embodiment of a process for storing data through the user interface of the application.

FIG. 5 is a flowchart of one embodiment of a process for configuring a data pattern.

FIG. 6 is a diagram of a system to provide data to a user interface over a network.

### DETAILED DESCRIPTION

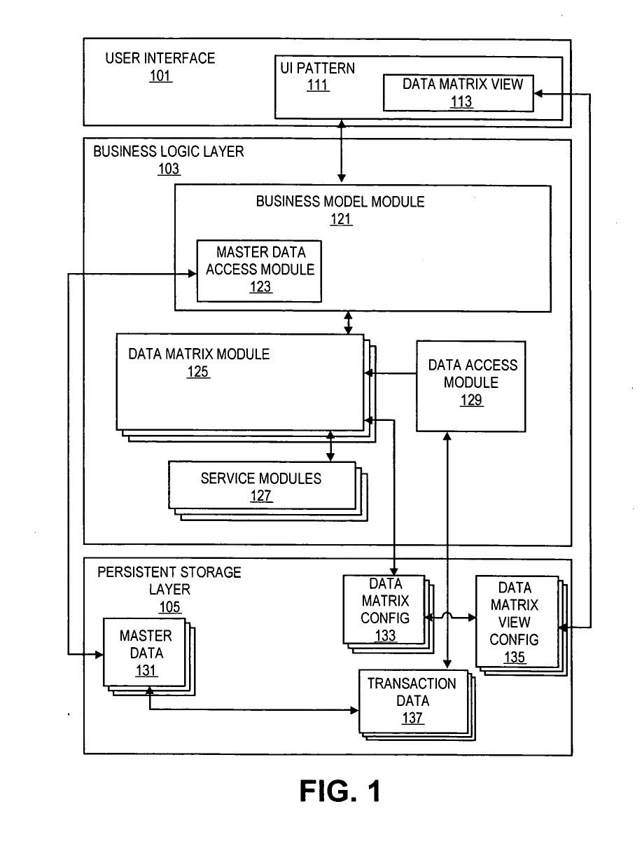

FIG. 1 is one embodiment of an application for altering and displaying data according to a pattern. A ‘pattern’ may be a representation of a process for handling a specific set of data associated with a process including a set of constituent data types and a layout for viewing this data. In one embodiment, the application may be conceptually divided into three discrete components: a user interface layer 101, business logic layer 103 or similar intermediate layer and persistent storage layer 105. The application may function to allow a user to access, store, alter, and view data associated with a currently selected pattern.

In one embodiment, user interface layer 101 may support the display of data according to any available user interface pattern 111. In one embodiment, a user interface pattern 111 may be a run time instance of a selected pattern. A user may select the pattern to be displayed through the user interface layer 101. In response, user interface layer 101 may generate a data matrix view module 113 to determine the configuration and data to be displayed in user interface pattern 111. Data matrix view module 113 may be a retrieved set of data representing the configuration and contents of the pattern to be displayed through the user interface 101. Data matrix view module 113 may be retrieved from persistent storage layer 105 where it is stored in a data matrix view configuration module 135. Data matrix view module 113 may contain information about layout, data fields, data and similar information related to a specific pattern. In one embodiment, multiple patterns may exist to be displayed each stored as a separate configuration module 135.

In one embodiment, user interface 101 may be in communication with an intermediate layer, for example a business logic layer 103. Communication between layers and their constituent modules in the application may be carried out through well defined interfaces. The interfaces between modules may define the interactions of the modules. The interfaces between modules may support data formats that fully describe time series data and objects or similar data and data structures. The communication between the layers and modules in the layers, for example the modules in the business logic layer 103 are ‘loosely coupled’ together. As used herein ‘loosely coupled’ denotes that the modules are largely decoupled or independent from one another allowing the replacement, update, customization or other alteration of one module without affecting the functionality of other modules. The modules communicate data through the well defined interfaces thereby providing the loose coupling.

In one embodiment, user interface pattern 111 may communicate with business model module 121 or other business logic layer 103 modules to retrieve needed data to be displayed to a user. Business model module 121 may be a set of functions and operations to be performed on data from persistent storage layer 105. In one embodiment, business model module 121 may operate on basic data to derive additional data that is requested by user interface 101. For example, in the context of a user interface pattern for supply chain management, a user may select a user interface pattern that displays an aggregate demand for a product. Demand for a product may be stored in a persistent storage layer on a location by location basis. Business model module 121 may accumulate this data to generate a total demand to be displayed to a user through the user interface. In another embodiment, business model module 121 may be replaced with an equivalent model module for handling other data types.

In one embodiment, business model module 121 may be primarily responsible for handling master data 131. In one embodiment, business model module 121 may access data such as master data 131 in persistent storage 105 through master data access module 123. Master data access module 123 may retrieve data required by business model module 121 to return to user interface 101 or to generate data to be returned to user interface 101. Master data 131 may be data related to business, such as inventory data, price data, shipping data, employee data and similar data. In another embodiment, master data 131 may be any type of data including sports data, personal data, research data and similar data. Master data 131 may include data that may be altered or data that is fixed.

In one embodiment, business model module 121 may be in communication with data matrix module 125 which may be responsible for retrieving, generating, and deriving transactional data required by the user interface or selected pattern. Data matrix module 125 manipulates and handles transactional data stored in persistent storage layer 105. In one embodiment, data matrix module 125 may manage the application of service modules 127 to transactional data. Data matrix module 125 models the business pattern or similar pattern being displayed by the user interface. In one embodiment, data matrix module 125 may generate or retrieve only that data that is required by the user interface and any data that is needed to generate the required data. For example, if data related to ‘projected demand’ for a product were to be displayed via the user interface then requisite values for generating ‘projected demand’ such as ‘recent order data’ may be retrieved to generate the ‘projected demand’ even if the ‘recent order data’ is not to be displayed via the user interface. In another embodiment, data matrix module 125 may generate or retrieve data in addition to the data that is required by the user interface. Data matrix module 125 may receive master data from business model module 121 and may retrieve transactional data via a data access module 129. Data matrix module provides a temporary storage and state for the data that allows a user to adjust, alter or manipulate the data and functions of the data and data matrix without affecting the persistent storage of the data or functions. This data tracked by the data matrix may be referred to as temporary data. If the user decides to confirm the changes in the temporary data, then the temporary data may at that time be stored in persistent storage layer 105 in the appropriate master data module 131, transaction data module 137, data matrix configuration module 133 or similar storage modules.

In one embodiment, service modules 127 may be any set of modular functions that may be applied to master or transactional data. For example, services may include accumulation calculations, forecast calculations, route finding functions and similar functions. These functions are organized as modular services to be used by multiple patterns. This reusability improves the efficiency in designing patterns and in updating services.

In one embodiment data access module 129 may be used to retrieve needed data from persistent storage layer 105. Data access module 129 may generate queries and retrieval commands that are specific to the type of persistent storage devices or system utilized to implement the persistent storage layer. In one embodiment, data access module 129 may utilize a known structure or organization of persistent storage module 105 to assist in data retrieval. Data retrieved from persistent storage layer 105 may be in the form of conventional data, object oriented data, or similar data structures. For example, time-series data may be structured into an object format for use with the data management system.

In one embodiment, persistent storage layer 105 may be implemented as a database, set of databases or similar storage mechanisms. Persistent storage layer 105 may be composed of a single storage device or a set of storage devices. Persistent storage module 105 may store master data 131, data matrix configuration 133, transaction data 137, data matrix view configuration 135 and similar data. Master data 131, data matrix configuration 133, transaction data 137 and data matrix view configuration 135 may each be stored in a discrete section of persistent storage module 105 such as sets of tables in a database or similar storage accommodations. In one embodiment, persistent storage module 105 may store multiple master data 131, data matrix configuration 133, data matrix view configuration 135 and transaction data 137 modules. Each module may be associated with a different pattern.

In one embodiment, the application may include a discrete user interface layer 101, intermediate or business logic layer 103, and persistent storage layer 105. The constituent modules of these layers are discrete components and independent in function from one another. This allows for easy update, alteration, customization and replacement of components without affecting other components saving development time and money.

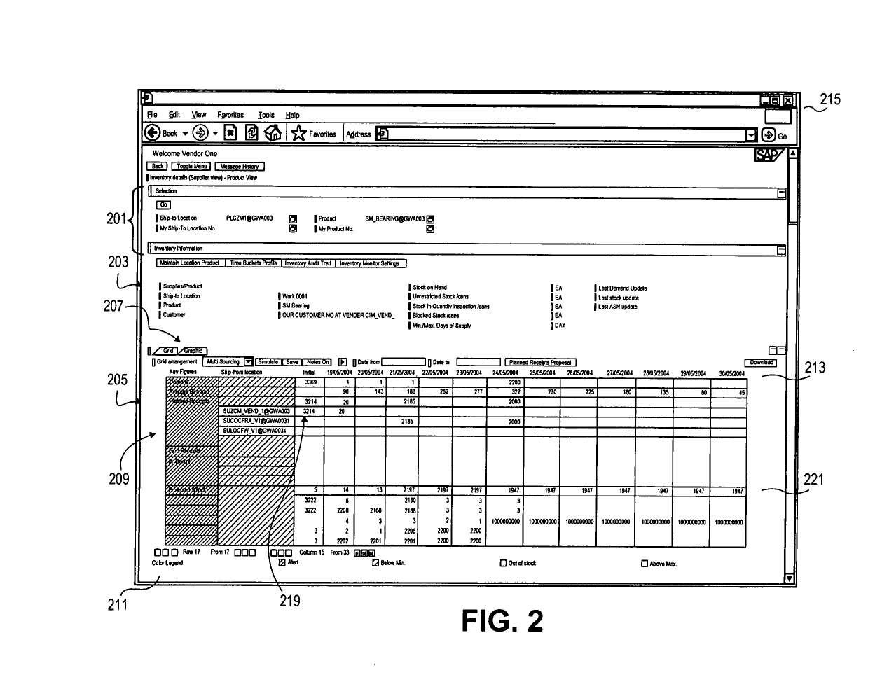

FIG. 2 is a diagram of an example user interface for the application. In one embodiment, the user interface may be provided through a browser application 215 or similar application. In another embodiment, the user interface may be provided by a specialized application. The user interface may be partially or completely resident on a client machine or on a server machine.

In one embodiment, the user interface may include a selection interface 201. The selection interface may allow a user to select a pattern to view. Multiple patterns may be available to view corresponding sets of data or a single data set. Multiple patterns may also be available that are associated with different data sets. A label or identifier may be displayed for each pattern. The name of a pattern may be specified by a user by text input or similar input mechanism. A selection mechanism may be used such as a drop down menu, set of buttons or similar selection mechanism. A single pattern may be used for multiple data sets. A pattern may be specialized for a particular data set, such as business data, sports data, accounting data or similar data sets.

In one embodiment, detailed information 203 for a field or key figure associated with a pattern may be displayed via the user interface. Subcategories or related data fields or related key figures may be displayed along with the values stored therein.

In one embodiment, the pattern and data may be displayed in the form of a grid system 213. Grid system 213 may have a set of rows and columns defining a grid of fields determined by the settings of the pattern. The rows and columns may be specified or defined by a user. The layout of the grid may be altered by a set of selections that further define the display. For example, the orientation of the grid, number of columns or rows, range of data displayed, sizing and similar characteristics may be customized by a user during the use of the user interface. These settings may be stored for future use and application.

In one embodiment, the data set may be composed of a set of key figures 205. Key figures 205 may be any basic stored data type or type derived from the basic stored data. In one embodiment, key figures may be data structures of related data such as time series data. The key figure may be formatted as an object. In one embodiment, key figures may include an identity, name, a set of independent variables, table of time related values and similar data. For example, in a supply chain management usage, key figures may exist for demand, average demand, planned receipts, firm receipts, in transit products, projected stocks and similar data types. Key figures may be selected for display by a user from a selection mechanism listing key figures associated with the current pattern. In one embodiment, key figures 205 may be displayed in a column, row or similar organization.

In one embodiment, key figures 205 may be associated with a set of independent variables that constitute aggregate levels or subcategories that break down the data of the key figures into a set of subcategory fields. For example, a key figure such as ‘planned shipment’ may be associated with ship from locations or ship to locations. Data may be displayed for each independent variable and for the aggregate of the independent variables. The user may select to expand a key figure display to include an independent variable by a selection mechanism 209 such as a set of buttons, toggle or similar selection mechanism. This mechanism allows a user to manipulate the degree of detail at which data is being viewed.

In one embodiment, data in the fields 219 displayed through the grid may be directly modifiable through the grid by selecting the field 219 in the grid and replacing the value in the field. A user may alter any number of values displayed in the grid and initiate a recalculation of derived values to update a view of the data. The changes to the data may be stored in a persistent storage device by selecting a confirmation indicator. In one embodiment, the data associated with key figures and their subtypes may be stored in a time series constituted from a set of time bucket fields that are a part of the key figure data structure. A time series may be a set of associated data where constituent values may be tied to a separate date or time. A user may select any date or time range to be displayed in the grid. The data displayed and aggregate or derived values displayed may be calculated using business logic and available service for the selected time range.

In one embodiment, sections of the grid may be colored or highlighted. A set of conditions may be defined by a user for a pattern that trigger the coloration of the fields in the grid. Separate triggers may be defined for each color that is used. For example, data fields associated with a projected stock field may be colored for dates where the projected stock falls below desired levels. Different colors may be used to designate how far off the projected stock levels are from a desired level. A color legend may be displayed to provide a definition to the user for the color scheme employed with the pattern.

In one embodiment, data associated with key figures may be displayed graphically. The graphic display of data may be in the form of charts including bar charts, line charts and similar charting systems. The graphic display may utilize any graphical method or modeling system suitable for the data type being displayed.

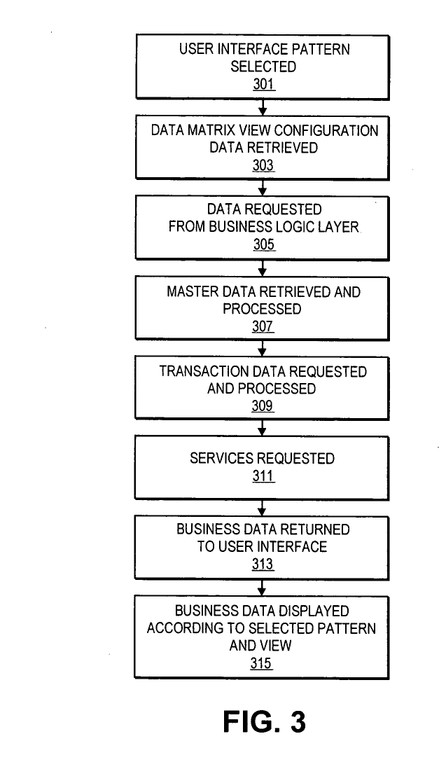

FIG. 3 is a flowchart of one embodiment of an example process for generating a display of data in a pattern. In this example, a business application environment is described. Other environments and data sets may also be handled by analogous processes. In one embodiment, the generation of a display may be initiated by a user selecting a pattern or data set to be displayed (block 301). The user may select the pattern or data by use of a graphical user interface selection mechanism such as a drop down menu, buttons, list or similar mechanism. A pattern or data set may be designated by a label describing the pattern or data set. A pattern may be tied to a particular data set. For example, a pattern may be designed for use with supply chain management data display and its selection may automatically retrieve associated supply chain management data.

In one embodiment, after a pattern has been determined, the user interface may retrieve data matrix view configuration data (block 303). The data matrix view configuration data may be stored in a persistent storage system. The data matrix view configuration data may contain data for configuring the layout of a pattern. The data matrix view configuration data may include a listing of key figures, the order in which the key figures appear on a screen, on which screen each key figure appears and similar information. In one embodiment, the data matrix view configuration may include data regarding the layout of columns or rows associated with values or time series data.

In one embodiment, the data associated with the selected view may be requested from the intermediate or business logic layer (block 305). In one embodiment, the request may be made via a procedure call or similar argument passing or communication system, when the business logic layer is on a machine local to the user interface. In another embodiment, the business logic layer may be remote from the user interface. The user interface may send a request over a network using remote procedure calls, object request brokers (ORBs) or similar messaging or communication methods. The user interface may send the business layer information indicating the pattern selected by the user and request the associated data required to be displayed in the pattern. In another embodiment, the user interface may supply additional information about the current view of the user interface to allow the business logic layer to return only that data that is needed for the business pattern in the current data matrix view configuration.

In one embodiment, a business model module in the business logic layer may handle the retrieval of master data from the persistent storage layer (block 307). The business model module may utilize a master data access module to access and retrieve master data from the persistent storage layer. In one embodiment, master data may include definitional data for a business pattern and its associated data set. For example, a pattern for supply chain management may provide location and product set information, key figure lists and similar structural data.

In one embodiment, a data matrix module in the business logic layer may retrieve transactional data and data matrix configuration data using a data access module from the persistent storage layer (block 309). The transactional and configuration data may be retrieved that corresponds to the selected pattern or data set. The data matrix configuration may include definitions of the functional relationships among key figures, e.g., which key figures are stored and which key figures are computed, information about the use of services and similar information. In one embodiment, the data matrix may utilize services to generate the data needed for the requested pattern and data matrix view (block 311).

In one embodiment, after the requested data has been collected and calculated the data may be returned to the user interface (block 313). The data may be sent to the user interface by a return operation, messaging, use of an ORB, network communication systems or similar communication systems. The data may then be displayed through the user interface according to the selected pattern and current view of the data matrix (block 315).

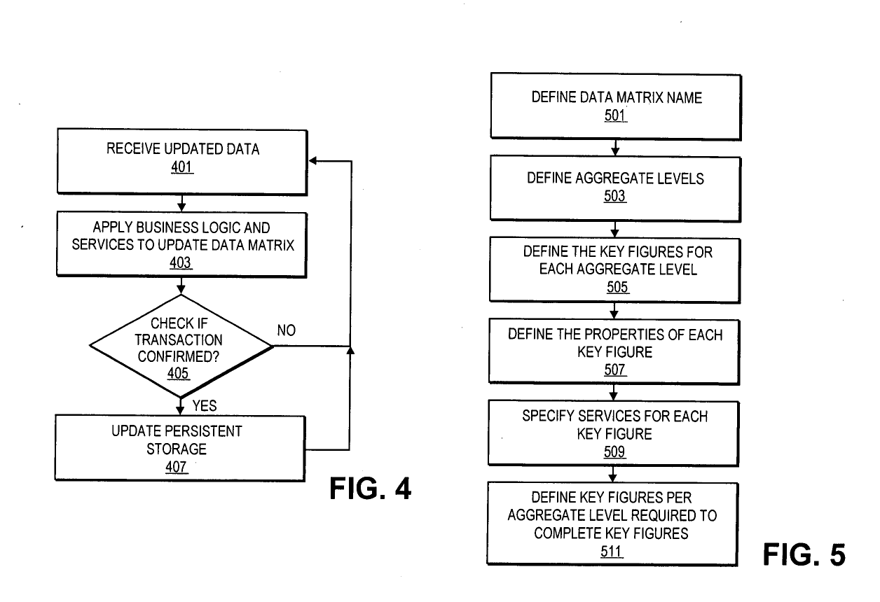

FIG. 4 is a flowchart of one embodiment of a process for updating data through the user interface and pattern. A user may input data or alter data displayed through the grid or graphical display systems of the user interface by selecting the field containing the data and replacing or altering the data in the field. A user may alter any number of fields or values (block 401). The user may also alter the definitions, logic, or services applied to data. These properties and functions may be altered through a specialized screen or set of screens in the user interface. The user may also request that the displayed data be updated to reflect the changes to the values (block 403). This update and the changes may not be permanent allowing a user to experiment with the data and properties of the current pattern.

In one embodiment, if a user determines that the changes to the pattern are to be kept, the user may select a confirmation option (block 405). The changes to the data or properties of the pattern may then be sent for storage through the data access module to the persistent storage (block 407). In the alternative, the user may select to discard the changes to the data matrix. The data matrix may be returned to the persistent storage state.

FIG. 5 is a flowchart of one embodiment of a process for defining a pattern in the form of the associated data matrix. In one embodiment, a user may set the name of the data matrix that defines the pattern (block 501). The pattern may utilize a set of aggregate levels to group independent variables of key figures. The aggregate levels may be defined by the user (block 503). The set of aggregate levels may define a set of relationships between key figures or a hierarchy of key figures. Aggregate level definition affects the manner in which data related to key figures may be displayed and calculated for display. The relationships between key figures may define which key figures are independent variables of other key figures. In one embodiment, this system may be defined by a user specifying which key figures are a part of each aggregate level (block 505). For example, in a supply chain management pattern, an aggregate level may be defined as a location/product/supplier aggregate level. This denotes that a location value may have product and supplier independent variables. The number of items in inventory may be viewed in total at the highest level and subdivided to view the number of items in inventory or specific products at a given location and then further subdivided into the number of products at a given location from a particular supplier.

In one embodiment, each key figure may have a set of properties or characteristics for a given data matrix or pattern. A user may define these properties by selecting them through the configuration interface or by entering them through the configuration interface (block 507). Properties and characteristics of a key figure may include whether the key figure is a value or set of values stored in persistent storage layer or is a computed or derived value and similar properties and characteristics. A user may also define a set of services that are utilized to calculate a key figure or are available to a data matrix (block 509). The services may be functions, procedures or similar programs that may be used to calculate values for any number of key figures. These services may be available to be used by any number of data matrices. This allows the services to be reused by multiple data matrices to calculate or assist in deriving any number of key figures or intermediate values to minimize redundancy and minimize the amount of programming required to define a pattern.

In one embodiment, a set of dependencies may be defined through the configuration which specifies the key figures per aggregate level that are required to compute a required key figure (block 511). The configuration interface may also allow a user to define a set of user interface events that may be displayed through the user interface. These events may be generated by a service. For example, a planned shipment proposal may be generated using a service. Other aspects of the user interface may also be specified through the configuration interface including the order of columns and rows, color schemes, and similar properties. In one embodiment, the definition of the various aspects of the data matrix including aggregate levels, key figures, key figure properties, services and similar aspects may be defined in any order.

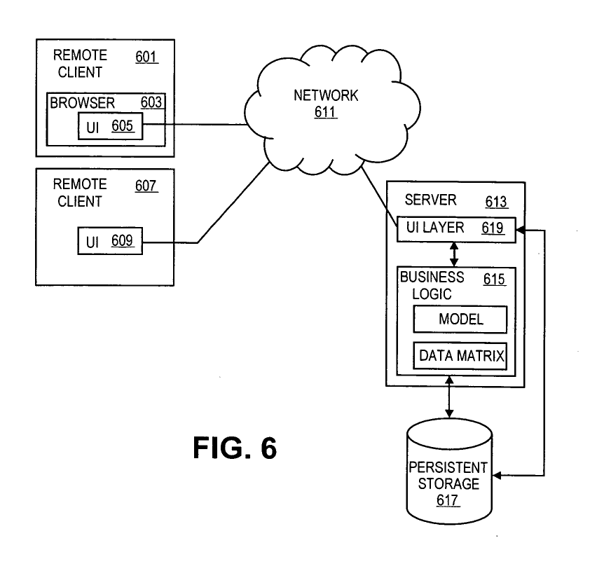

FIG. 6 is one embodiment of a network environment utilizing a remote client to provide a user interface. In one embodiment, a user interface 605 may be accessed on a remote client machine 601. The user interface may be provided through a browser 603 or similar application. In another embodiment, a user interface 609 may be a stand alone or dedicated application on a remote client 607. The user interface 605 may communicate with a user interface layer 619 on server 613 over network 611. User interface layer 619 may generate or organize the data to be displayed by user interface 605 and 609. For example, in a web browser environment, the user interface layer 619 may generate the html code that defines the layout of the data in user interface 605. Network 611 may be a local area network, wide area network, the Internet or similar network.

In one embodiment, user interface layer 619 may communicate with an intermediate layer such as a business logic layer 615 on server 613 and persistent storage 617 to obtain data and configuration information to be sent to the user interface 605. Server 613 may be in communication with or include a persistent storage system 617. Persistent storage system 617 may be any type of storage device or set of storage devices.

In one embodiment, user interface layer 619, business logic layer 615 and persistent data layer 617 may be implemented using an object oriented paradigm. For example, the system may implement using the Java programming language and Java Virtual Machine, including the Java 2 Enterprise Edition (“J2EE”) which support Enterprise Java Bean (“EJB”) components and EJB containers (at the business layer) and Servlets and Java Server Pages (“JSP”) (at the user interface layer). In another embodiment, the system may be implemented in the context of various other software platforms including, by way of example, Microsoft NET platforms and/or the Advanced Business Application Programming (“ABAP”) platforms including SAP Business Server Pages (BSP) developed by SAP AG.

In one embodiment, the system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An apparatus comprising:
a user interface to display data according to a pattern;
an intermediate layer having a set of loosely coupled modules to generate and retrieve data to be displayed in the pattern; and
a persistent storage system loosely coupled with the data matrix module to store a permanent state of the data.

2. The apparatus of claim 1, wherein the intermediate layer further comprises:
a data matrix module to track a temporary state of the data.

3. The apparatus of claim 1, wherein the intermediate layer further comprises:
a data access module to manage the retrieval and storage of the data.

4. The apparatus of claim 2, wherein the intermediate layer further comprises:
a service module loosely coupled to the data matrix module to provide a specific functionality to the data matrix module.

5. The apparatus of claim 1, wherein the intermediate layer further comprises:
a model module loosely coupled with the data matrix to provide business logic.

6. The apparatus of claim 1, wherein the data is time series data.

7. The apparatus of claim 1, further comprising:
a data matrix view configuration module in communication with the user interface to store configuration data for the user interface.

8. A method comprising:
receiving an interface data pattern selection;
retrieving interface data pattern view configuration data comprising aggregate level and key figure information;
retrieving data associated with the data pattern;
displaying the data according to the interface data pattern view configuration; and
displaying data based on its relation to a key figure and aggregate level.

9. The method of claim 8, further comprising:
processing the data according to business logic.

10. The method of claim 8, further comprising:
tracking a temporary state of the data.

11. The method of claim 10, further comprising:
storing the temporary state of the data in a persistent storage system upon receipt of a confirmation indicator.

12. The method of claim 8, further comprising:
accessing a service from a service module to generate data to be displayed.

13. A method comprising:
defining an identity for a data matrix, the data matrix representing a data pattern for a specific process;
defining an aggregate level associated with the pattern; and
defining a key figure for the aggregate level.

14. The method of claim 13, further comprising:
defining a property of the key figure.

15. The method of claim 13, further comprising:
identifying a service for a key figure computation.

16. The method of claim 13, further comprising:
configuring the order of one of rows and columns.

17. An apparatus comprising:
means for selecting a data pattern associated with a specific process;
means for selecting pattern configuration view data;
means for retrieving data associated with the data pattern comprising key figure and aggregate level information;
means for displaying the data according to the pattern view configuration; and
means for displaying data based on its relation to a key figure and aggregate level.

18. The apparatus of claim 17, further comprising:
means for processing the data according to business logic.

19. The apparatus of claim 17, further comprising:
means for tracking a temporary state of the data.

20. The apparatus of claim 17, further comprising:
means for storing the state of the data in a persistent storage system.

21. The method of claim 17, further comprising:
means for accessing a service from a service module to generate data to be displayed.

22. A machine readable medium having instructions stored therein which when executed cause a machine to perform a set of operations comprising:
receiving an interface data pattern selection;
retrieving interface data pattern view configuration data;
retrieving data associated with the data pattern comprising key figure and aggregate level information;
displaying the data according to the interface pattern view; and
displaying data based on its relation to a key figure and aggregate level.

23. The machine readable medium of claim 22, having further instructions stored therein which when executed cause a machine to perform a set of operations further comprising:
processing the data according to business logic.

24. The machine readable medium of claim 22, having further instructions stored therein which when executed cause a machine to perform a set of operations further comprising:
tracking a temporary state of the data.

25. The machine readable medium of claim 22, having further instructions stored therein which when executed cause a machine to perform a set of operations further comprising:
storing the temporary state of the data in a persistent storage system.

26. The machine readable medium of claim 22, having further instructions stored therein which when executed cause a machine to perform a set of operations further comprising:
accessing a service from a service module.
